(19) United States
(12) Patent Application Publication
(10) Pub. No.: US 2012/0132045 A1
(43) Pub. Date: May 31, 2012

(54) SUSPENSION OF ABRASIVE GRAINS

(75) Inventors: Ana-Maria Popa, Cavaillon (FR); Jan Olaf Roszinski, Soegne (NO); Siv M. Emanuelsen, Lillesand (NO); Fabio Neuman, Lillesand (NO)

(73) Assignee: Saint-Gobain Centre de Recherches et D'etudes European, Courbevoie (FR)

(21) Appl. No.: 13/382,677

(22) PCT Filed: Jul. 9, 2010
(86) PCT No.: PCT/IB10/53161

§ 371 Date: Feb. 1, 2012

(30) Foreign Application Priority Data
Jul. 9, 2009 (FR) 0954792

(51) Int. Cl. C09K 3/14; B26D 1/00; B26D 7/20

(52) U.S. Cl. 83/13; 51/307; 83/651.1

(57) ABSTRACT

The invention relates to a suspension including a set of abrasive grains and a binder, said suspension being characterized in that: the particle size fraction D₄₀-D₆₀ of said set of abrasive grains comprises more than 15 vol % and less than 80 vol % of grains having a circularity of less than 0.85, the percentiles D₄₀ and D₆₀ being the percentiles of the cumulative particle size distribution curve of grain sizes corresponding to the grain sizes enabling the separation of the fractions consisting of 40 and 60 vol % of the grains having the largest size, respectively; and the abrasive grains are more than 25 wt % and less than 49.5 wt % of said suspension.

### TECHNICAL FIELD

The present invention relates to a suspension of abrasive grains, especially intended for machining silicon ingots, to an abrasive tool, and especially an abrasive wire, loaded with this suspension, and to a process for sawing an ingot using such a suspension or such an abrasive tool.

### PRIOR ART

Conventionally, the manufacture of silicon wafers comprises a step of sawing silicon ingots into slices. For this purpose, the silicon ingots are pushed against an abrasive wire rotating in a loop while being reloaded by passing through a suspension of abrasive grains.

Processes for sawing silicon ingots and machines that can be used for carrying out these processes are especially described in US 2006/249134, U.S. Pat. No. 5,937,844 or WO 2005/095076.

The silicon wafers may be intended for electronic applications or for the manufacture of photovoltaic cells. In particular, in the latter application, there is a need to manufacture silicon wafers having a reduced thickness, of the order of 200 μm, in order to limit the amount of silicon needed to product one Watt.

There is also a need for high sawing speeds in order to increase productivity.

These constraints of thin thickness and of high sawing speed result however in unsatisfactory scrap rates. Indeed, a large proportion of the wafers manufactured have variations in thickness along their length, deformations or defects at their surface. Some wafers even have crack initiation sites or are broken during the sawing operation.

Research has therefore been carried out in order to improve the performances of the suspensions used. In particular JP 10-180 608 recommends the use of abrasive grains in the form of small plates having a thickness at most equal to one quarter of their length and of their width.

JP 2003-041240 recommends a dispersion of the grain sizes that is narrowed around the median size. JP 2003-041240 also states that the average aspect ratio should be greater than or equal to 0.59. The grains disclosed in JP 2003-041240 would make it possible to reduce the thickness variations along the wafers manufactured.

One objective of the invention is to at least partially solve one or more of the aforementioned problems, and in particular to improve the productivity of the processes for manufacturing silicon wafers.

### SUMMARY OF THE INVENTION

The invention proposes a suspension or “slurry”, especially intended for machining silicon ingots, comprising an assembly of abrasive grains and a binder, said suspension being characterized in that:
the D₄₀-D₆₀ particle size fraction of said assembly of abrasive grains comprises more than 15%, more than 18%, more than 22%, preferably more than 25%, and less than 80%, less than 70%, less than 60%, preferably less than 50%, preferably less than 40%, as volume percentages, of grains having a circularity of less than 0.85, the D₄₀ and D₆₀ percentiles being the percentiles of the cumulative particle size distribution curve of the grain sizes corresponding to the grain sizes that make it possible to separate the fractions constituted of 40% and 60%, as volume percentages, respectively, of the grains having the largest sizes; and
the abrasive grains represent more than 25%, more than 30%, more than 35%, more than 37%, and less than 49.5% or even less than 46%, preferably less than 45%, preferably less than 43% of the mass of said suspension.

As will be seen in greater detail in the remainder of the description, a suspension according to the invention is particularly efficient for sawing ingots. In order to explain it theoretically, the inventors have discovered that the suspensions containing a high proportion of elongated grains among the large grains is advantageous and that, for these suspensions specifically, there is an optimal range for the weight content of grains. Surprisingly, they have demonstrated that this optimal range for the weight content is lower than those customarily recommended is advantageous.

The inventors have also discovered that, in one preferred embodiment of the invention, a suspension according to the invention does not generate marks on the machined wafers (due to the rubbing of the abrasive tool) and allows a good renewal of the grains on this tool during the reloading thereof.

When the median size D₅₀ of the assembly of abrasive grains is greater than 5 μm, or even greater than 6 μm and less than 9 μm, or even less than 8 μm, the abrasive grains preferably represent more than 30% and less than 46% of the mass of said suspension.

When the median size D₅₀ of the assembly of abrasive grains is greater than 8 μm, or even greater than 9 μm and less than 12 μm, or even less than 10 μm, the abrasive grains preferably represent more than 35% and less than 47% of the mass of said suspension.

When the median size D₅₀ of the assembly of abrasive grains is greater than 12 μm and less than 20 μm, or even less than 15 μm, the abrasive grains preferably represent more than 31% and less than 48% of the mass of said suspension.

In one embodiment, the ratio of the volume percentage S(D₄₀-D₆₀) of grains having a circularity of less than 0.85 in the D₄₀-D₆₀ particle size fraction of said assembly of abrasive grains divided by the median size D₅₀, or “ratio R₄₀₋₆₀”, is greater than 1 and less than 5, preferably less than 3, or even less than 2.7, the circularity and the percentiles being as defined above.

This ratio may be greater than 1.5, or even greater than 1.7.

In one embodiment, the assembly of abrasive grains is such that:

10%<Δ₃₋₁₀₋₂₀<60%, and/or

5%<Δ₁₀₋₂₀₋₄₀<40%, and/or

20%<Δ₂₀₋₄₀₋₆₀<50% and/or

0%<Δ₄₀₋₆₀₋₈₀<20%, and/or

5%<Δ₆₀₋₈₀₋₉₇<40%,

“Δₙ₋ₘ₋ₚ” being the ratio (S(Dₙ-Dₘ)−S(Dₘ-Dₚ))/S(Dₘ-Dₚ) as a percentage,
“S(Dᵢ-Dⱼ)” being the volume percentage of grains having a circularity of less than 0.85 in the Dᵢ-Dⱼ particle size fraction.

In one embodiment:
Δ₄₀₋₆₀₋₈₀<7%;
   preferably
20%<Δ₂₀₋₄₀₋₆₀<50%, and
0%<Δ₄₀₋₆₀₋₈₀<20%, or even Δ₄₀₋₆₀₋₈₀<7%.

In one embodiment:
5%<Δ₁₀₋₂₀₋₄₀<40%, or even Δ₁₀₋₂₀₋₄₀<20%, and
0%<Δ₄₀₋₆₀₋₈₀<20%, or even Δ₄₀₋₆₀₋₈₀<7%.

In one preferred embodiment:
10%<Δ₃₋₁₀₋₂₀<60%, and
5%<Δ₁₀₋₂₀₋₄₀<40%, and
20%<Δ₂₀₋₄₀₋₆₀<50%, and
0%<Δ₄₀₋₆₀₋₈₀<20%, and
5%<Δ₆₀₋₈₀₋₉₇<40%.

Δ₃₋₁₀₋₂₀ may be greater than 20%, or even greater than 25%

Δ₁₀₋₂₀₋₄₀ may be less than 35%, or even less than 30%, or less than 25%.

Δ₂₀₋₄₀₋₆₀ may be greater than 15%, or even greater than 25%, or greater than 35%.

Δ₄₀₋₆₀₋₈₀ may be less than 15%, less than 10% or less than 7%, or even less than 5%_{.}

Δ₆₀₋₈₀₋₉₇ may be greater than 10%, or even greater than 15% or even greater than 20%.

Preferably, several of these conditions are met.

Very significantly, these conditions make it possible to limit the variations of the proportion of elongated grains from one particle size fraction to the next. The inventors have discovered that the result of this is an improvement in the performances during the sawing of the ingots.

A suspension according to the invention may especially also exhibit one or more of the following optional characteristics:
The D₂₀-D₄₀ particle size fraction may comprise more than 15%, preferably more than 20%, or even more than 25%, as a volume percentage, of grains having a circularity (C) of less than 0.85.
The D₁₀-D₂₀ particle size fraction may comprise more than 15%, preferably more than 25%, or even more than 30%, as a volume percentage, of grains having a circularity (C) of less than 0.85.
The D₃-D₁₀ particle size fraction may comprise more than 30%, preferably more than 40%, or even more than 50%, as a volume percentage, of grains having a circularity (C) of less than 0.85.
The D₂₀-D₄₀ particle size fraction and the D₄₀-D₆₀ particle size fraction may simultaneously comprise more than 15%, more than 20% and/or less than 40%, less than 35%, as volume percentages, of grains having a circularity of less than 0.85.
The median size D₅₀ may be less than 30 μm, or even less than 20 μm and/or greater than 3 μm, greater than 5 μm, or even greater than 8 μm.
The material of the abrasive grains may have a Vickers HV_{0.5} micro hardness of greater than 7 GPa. This micro hardness may be determined by an average out of at least 10 measurements of impressions made with a square base diamond indenter with an apical angle equal to 136° applied to a sample of grains.
The abrasive grains may especially comprise more than 95%, preferably more than 97.5%, of silicon carbide SiC, as a weight percentage, the silicon carbide preferably being in alpha crystalline form.
The abrasive grains have a specific surface area preferably greater than 1.0 m²/g, or even greater than 1.2 m²/g for a median size between 5 and 15 microns. The specific surface area is conventionally calculated by the BET (Brunauer Emmet Teller) method as described in Journal of American Chemical Society 60 (1938), pages 309 to 316.
The assembly of abrasive grains preferably has a weight content of oxygen between 0.2% and 0.6% and preferably between 0.4% and 0.5%. The weight content of oxygen is measured by the LECO method.

In one particular embodiment, the median size D₅₀ is greater than 8 μm and the D₄₀-D₆₀ particle size fraction comprises more than 15%, or more than 20%, as a volume percentage, of grains having a circularity of less than 0.85.

The binder is preferably an organic binder.

Preferably, a suspension according to the invention has a viscosity between 20 and 30 cPa·s, measured with a Brookfield DV-II+ Pro viscometer using spindle 63 and a rotational speed of 200 rpm (revolutions per minute).

The invention also relates to a tool comprising abrasive grains fastened to a support or agglomerated with one another by means of a suspension according to the invention. The tool may in particular be a support wire coated with a suspension according to the invention, for example an abrasive wire intended for sawing ingots, and especially silicon ingots.

The invention also relates to a process for machining an ingot, and especially a process for sawing an ingot using a tool according to the invention, and especially an abrasive wire according to the invention. The ingot may comprise more than 50%, more than 80%, more than 90%, more than 95%, more than 99%, more than 99.9%, or even 100% of a constituent chosen from a semiconductor material, in particular monocrystalline or polycrystalline silicon, an arsenide, in particular gallium arsenide (GaAs), indium phosphide (InP), a metal oxide or a ferrite. The process may be adapted so as to obtain, at the end of the sawing operation, a wafer having a thickness of less than 200 μm, less than 150 μm, or even less than or equal to 100 μm.

Preferably, the tool is reloaded by passing through a suspension according to the invention.

The invention also relates to a wafer obtained in accordance with a machining process according to the invention.

Furthermore, the inventors have discovered that the weight content of abrasive grains in the suspension which is optimal for maximizing the sawing speed depends on the specific surface area of the powder, conventionally measured by BET. The larger this specific surface area, the higher said weight content must be.

The invention therefore also relates to a process for machining an ingot, comprising the following operations:
a. preparation of a suspension by mixing a powder of abrasive grains and a binder;
b. machining of said ingot using an abrasive tool that is reloaded by passing through said suspension;
   this process being noteworthy in that, for the preparation of said suspension, the weight content of abrasive grains in said suspension is adjusted as a function of the specific surface area of said powder.

The suspension may in particular be a suspension according to the invention.

### DEFINITIONS

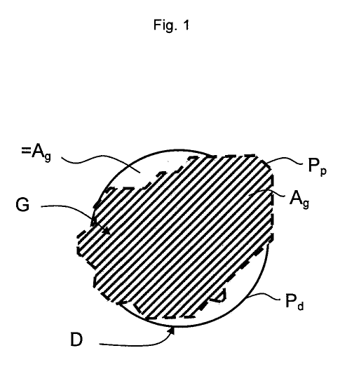

The term “grain” is understood to mean an individual solid product in a suspension or fastened to a support.
For the sake of clarity, the following terms are differentiated here: “powder” of grains, which is the particulate raw material used for manufacturing a suspension, and “assembly” of grains, which is constituted of the grains in the suspension. In other words, a powder becomes an assembly of grains when it is introduced into the suspension. Of course, the particle size distribution of an assembly of grains is identical to that of the corresponding powder.
For the sake of clarity, a grain having a circularity of less than 0.85 is referred to here as an “elongated grain” and a grain having a circularity greater than or equal to 0.85 is referred to as a “rounded grain”.
The “circularity” of a grain is conventionally determined in the following manner: the grains are put into suspension in a fluid so as to prevent any flocculation of the grains, that is to say any agglomeration. The inventors have, for example, carried out a suspension in which an SiC powder is dispersed in water using sodium hydroxide NaOH. Other dispersants known for dispersing SiC particles could however be used. A photograph of the suspension is taken and processed using a SYSMEX FPIA 3000 machine.
In order to evaluate the circularity “C” of a grain, the perimeter P_{d} of the disk D having an area equal to the area Aₚ of the grain G on the photograph (see FIG. 1) is determined. Furthermore, the perimeter Pₚ of this grain is determined. The circularity is equal to the ratio of P_{d}/Pₚ. Thus,

$$C = \frac{2 * \sqrt{π {A}_{p}}}{{P}_{p}} .$$

The more elongated the grain, the lower the circularity.
The operating manual of the SYSMEX FPIA 3000 also describes this procedure (see “detailed specification sheets” on www.malvern.co.uk).
The expression “curve of the cumulative particle size distribution of the grain sizes of the assembly of grains of a suspension” conventionally refers to the particle size distribution curve giving:
   plotted on the Y-axis, percentages such that a cumulative percentage p % represents the fraction of this assembly grouping together the p %, by volume, of the grains having the largest sizes, and
   plotted on the X-axis, the grain sizes Dₚ, Dₚ being the smallest possible grain size in the fraction represented by the cumulative percentage p % plotted on the Y-axis.
Such a particle size curve can be produced using a laser particle size analyzer. A SYSMEX FPIA 3000® device advantageously makes it possible to obtain such curves. In the examples below, the sizes were determined with such a device.
The term “percentile” or “centile” Dₚ conventionally refers to the grain size (plotted on the X-axis in the aforementioned curve) corresponding to the percentage, by volume, of p % plotted on the Y-axis. For example, 10%, by volume, of the grains have a size greater than or equal to D₁₀ and 90% of the grains, by volume, have a size strictly less than D₁₀.
The expression “median size” conventionally refers to the percentile D₅₀.
The term “Dₚ-D_{q}” denotes the particle size fraction comprising all the grains having a size greater than or equal to D_{q} and less than or equal to Dₚ.
The term “S(Dₚ-D_{q})” denotes the volume percentage of elongated grains in the Dₚ-D_{q} particle size fraction.
The term “Δₙ₋ₘ₋ₚ” denotes the ratio (S(Dₙ-Dₘ)−S(Dₘ-Dₚ))/S(Dₘ-Dₚ) as a percentage. For example, Δ₃₋₁₀₋₂₀=(S(D₃-D₁₀)−S(D₁₀-D₂₀))/S(D₁₀-D₂₀). Δₙ₋ₘ₋ₚ therefore indicates the relative growth of the proportion of elongated grains of the Dₙ-Dₘ particle size fraction to the Dₘ-Dₚ particle size fraction.
The term “suspension” denotes a liquid containing a substantially homogeneously dispersed powder, a suspension which may optionally contain a dispersant.

### BRIEF DESCRIPTION OF THE FIGURES

Other features and advantages of the invention will also appear on reading the following description and on examining the drawing, in which FIG. 1 illustrates the method used for determining the circularity of the grains.

### DETAILED DESCRIPTION

### Manufacturing Process

Any process known for manufacturing abrasive grains may be used in order to manufacture rounded grains and elongated grains. In order to manufacture elongated grains, reference may especially be made to the description of JP 2003-041240.

Depending on the proportion of elongated grains manufactured, steps of classification, of sorting, for example by screening, or of mixing various particle size fractions may be necessary in order to obtain proportions of elongated grains corresponding to those of an assembly of grains of a suspension according to the invention.

A powder which may be used for the manufacture of a suspension according to the invention, hereinafter “base powder”, may for example be manufactured according to a process comprising at least the following steps:
a) synthesis of a solid body, preferably at least of millimeter scale, that is to say of which all the dimensions exceed at least 1 mm, preferably by reaction, especially by carboreduction, for example by carboreduction of silica in order to produce silicon carbide (SiC), pressure sintering or isostatic pressing (IP), hot isostatic pressing (HIP), SPS (Spark Plasma Sintering) or else by fusion casting, especially by electric fusion casting;
b) optional reduction of said solid body to an assembly of particles, optionally by crushing;
c) preferably, selection, for example by screening, of particles having a size greater than the maximum size of the grains D_{0.5} of the powder to be manufactured and, preferably, selection of the particles having a size at least 2 times greater than this maximum size and/or less than 4 times this maximum size;
d) milling the solid body obtained in step a) or the particles obtained in step b) or in step c), preferably under conditions that promote shear stresses, in particular using a roll mill;
e) where appropriate, selection of grains resulting from step d) and belonging to particle size ranges determined so that the powder obtained can constitute an assembly of grains of a suspension in accordance with the invention;
f) optionally, iron removal in order to eliminate the possible magnetic particles introduced during the milling carried out in step d);
g) optionally, heat treatment or chemical treatment that makes it possible to eliminate undesirable chemical species, for example silica or an excess of carbon in the case of a silicon carbide (SiC) powder;
h) optionally, verification of the quality of the powder, preferably by sampling.

In step a), the objective is to manufacture solid bodies having a sufficient strength to “shatter” during milling. In other words, the solid bodies prepared should not be simple agglomerations of grains capable of crumbling during milling; such crumbling does not make it possible to obtain enough elongated grains for an industrial use. Any synthesis process can be envisioned, from simple tests that make it possible to research the most favorable conditions.

In the optional step b), the solid bodies are reduced, for example crushed, so as to increase the amount of particles capable of being selected during the optional step c).

The objective of the optional step c) is to guarantee that after shattering of the particles introduced into the mill, the grains obtained at the outlet of the mill will have sufficient sizes so that the powder remains relatively coarse.

For this purpose, it is preferable for the minimum size of the solid bodies or of the particles entering into the mill to be at least two times greater than the maximum size of the grains of the powder to be manufactured.

In step d), a mill is used that promotes shear stresses, preferably a roll mill.

Attrition mills are not considered to be suitable for effectively manufacturing a large amount of elongated grains.

In the case of a roll mill, the gap between rolls may be adjusted in order to modify the particle size distribution and the proportion of the elongated grains.

A supplementary step e), which is optional if the powder obtain at the end of step d) is satisfactory, may then be carried out in order to select the preferred particle size ranges. This step may comprise a classification, preferably by elutriation, that is to say by separation according to the density by agitation in water. Indeed, this technique is well suited to the fine particle size of the grains.

An optional step f) may also be carried out in order to eliminate, by iron removal, the magnetic particles introduced especially during step d). Preferably, this step is carried out using a high-intensity magnetic separator.

Where appropriate, in an optional subsequent step h), the quality of the powder obtained following milling is verified, preferably by sampling, for example using a microscope, a scanning electron microscope or by any known means that makes possible to check the shape of the grains.

Owing to this process, a base powder of abrasive grains is obtained.

Base Powder

The abrasive grains are preferably made of a material having a Vickers HV_{0.5} micro hardness of greater than 7 GPa.

The nature of the abrasive grains may especially be that of the abrasive grains used up to now as polishing or sawing materials. In particular, the grains may be made of a material chosen from the group constituted by silicon carbide, cerium oxide, diamond, boron nitride, alumina, zirconia, silica and combinations of one or more of these materials. Such abrasive grains are commercially available. By way of example, mention may be made of the silicon carbide GC™ (Green Silicon Carbide) and C™ (Black Silicon Carbide) manufactured by Fujimi Inc. or SIKA™ manufactured by Saint-Gobain Materials at Lillesand in Norway. The alumina powders may be chosen, for example, from FO (Fujimi Optical Emery), A (Regular Fused Alumina), WA (White Fused Alumina) and PWA (Platelet Calcined Alumina) manufactured by Fujimi Inc.

Grains of silicon carbide are particularly advantageous.

In one preferred embodiment, the abrasive grains comprise more than 95%, or even more than 97.5% of silicon carbide, as a weight percentage. The last 2.5% may be impurities. The term “impurities” is understood to mean the inevitable constituents unavoidably introduced with the raw materials during the manufacture of the grains. In particular, the compounds belonging to the group of oxides, nitrides, oxynitrides, carbides, oxycarbides, carbonitrides and metallic species of sodium and other alkali metals, iron, vanadium and chromium are generally impurities. As examples, mention may be made of CaO, Fe₂O₃ or Na₂O.

The silicon carbide grains preferably have a density of greater than 3.0. Preferably, the silicon carbide is crystallized in alpha form.

In one embodiment, the D₂₀ percentile is greater than 9 μm, greater than 11 μm, and/or less than 15 μm, less than 14 μm, or even less than 13 μm.

The D₄₀ percentile may be greater than 5 μm, or even greater than 8 μm and/or be less than 20 μm, or even less than 15 μm, or less than 10 μm.

The median size D₅₀ may be less than 30 μm, less than 20 μm, less than 15 μm and/or greater than 1 μm, greater than 3 μm, greater than 5 μm, greater than 7 μm, or even greater than 9 μm.

Suspension

A suspension conventionally results from a mixture of a base powder in a liquid binder.

The binder makes it possible to fasten the abrasive grains to a support, and in particular to a support wire intended for sawing ingots, and especially silicon ingots. This fastening may be rigid or, on the contrary, conventionally, allow a possibility of mobility of the grains relative to one another.

The binder is preferably an organic binder. The binder may comprise water, a base material and one or more additives.

The amount of water is preferably between 10 and 75% by weight relative to the weight of the suspension.

The base material may be chosen from alkali metal hydroxides such as lithium hydroxide, sodium hydroxide and potassium hydroxide, alkaline-earth metal hydroxides such as magnesium hydroxide, calcium hydroxide and barium hydroxide, and combinations of these various materials. The content of this base material is conventionally between 3.5% and 20% by weight relative to the total liquid weight of the suspension.

Among the additives, use is generally made of at least one lubricant.

A lubricant may especially be chosen from a polyethylene glycol, benzotriazole, oleic acid and mixtures thereof. A lubricant may be, for example, Rikamultinole manufactured by the company Rikashokai or Lunacoolant manufactured by Daichikagaku. The content of lubricant is preferably between 0 and 50% by weight relative to the weight of the suspension.

The binder may comprise a polymer or a copolymer formed from ethylene glycol monomers, preferably a polyethylene glycol. Other organic binders such as PVA or PMMA may be suitable as long as they can be in liquid form or put into solution.

The suspension may be manufactured by simply mixing the aforementioned raw materials. A process for manufacturing a suspension is especially described in US 2006/0 249 134.

Tools

For the sawing of silicon ingots, the suspension is conventionally placed on a support wire having, for example, a thickness between 100 and 200 μm.

The support wire may especially be constituted of hard steel or of an alloy such as a nickel-chromium alloy or an iron-nickel alloy or of a metal having a high melting point such as tungsten or molybdenum, or may be made of polyamide fibers.

Machining Process

According to a conventional sawing process, as explained in the introduction, an abrasive wire, guided by rollers, rotates in a loop, passing through a suspension in order to be reloaded with abrasive grains. It rubs against an ingot to be sawn, typically of the order of 200 mm in length and diameter, so as to cut a slice or “wafer” of this ingot.

The ingot may in particular be a polycrystalline silicon ingot having a purity of greater than 99.99% by weight.

According to one embodiment of the machining process according to the invention, the wafer is sawn so as to have a thickness of less than 200 μm, less than 180 μm, less than 150 μm, less than 130 μm, less than 120 μm, or even less than 100 μm.

Tests

Various suspensions of silicon carbide grains were tested.

The following tables characterize the powders of grains used for manufacturing these suspensions.

S % denotes the volume percentage of elongated grains in the various particle size fractions.

N % denotes the percentage by number of elongated grains in the various particle size fractions.

TABLE 1
Percentile (μm)

| Example | P1 | P2 |
|---|---|---|
| D₉₇ | 5.2 | 6.2 |
| D₈₀ | 6.9 | 7.8 |
| D₆₀ | 8.5 | 9.3 |
| D₅₀ | 9.2 | 10 |
| D₄₀ | 9.9 | 10.7 |
| D₂₀ | 11.8 | 12.4 |
| D₁₀ | 13.5 | 13.6 |
| D₃ | 16.2 | 15.6 |

TABLE 2
S %

| | P1 | P2 |
|---|---|---|
| D₈₀-D₉₇ | 18.6 | 8.6 |
| D₆₀-D₈₀ | 22.8 | 8.9 |
| D₄₀-D₆₀ | 23.7 | 9.6 |
| D₂₀-D₄₀ | 32.7 | 12.7 |
| D₁₀-D₂₀ | 38.5 | 15.1 |
| D₃-D₁₀ | 52.6 | 29.2 |

TABLE 3

| Example | Fraction | N % |
|---|---|---|
| P1 | D₃-D₁₀ | 1.8 |
| | D₂₀-D₄₀ | 6.9 |
| | D₄₀-D₆₀ | 10.4 |
| P2 | D₃-D₁₀ | 2.4 |
| | D₂₀-D₄₀ | 6.6 |
| | D₄₀-D₆₀ | 12.0 |

TABLE 4

| | | | | R₄₀₋₆₀ = |
|---|---|---|---|---|
| Example | Fraction | D₅₀ (μm) | R = S %/D₅₀ | S(D₄₀-D₆₀)/D₅₀ |
| P1 | D₄₀-D₆₀ | 9.2 | 2.57 | 2.57 |
| | D₂₀-D₄₀ | | 3.55 | |
| P2 | D₄₀-D₆₀ | 10 | 0.96 | 0.96 |
| | D₂₀-D₄₀ | | 1.27 | |

TABLE 5

| Example | Δ₃₋₁₀₋₂₀ | Δ₁₀₋₂₀₋₄₀ | Δ₂₀₋₄₀₋₆₀ | Δ₄₀₋₆₀₋₈₀ | Δ₆₀₋₈₀₋₉₇ |
|---|---|---|---|---|---|
| P1 | 36.6 | 17.7 | 37.9 | 3.9 | 22.5 |
| P2 | 93.4 | 18.9 | 32.3 | 7.8 | 3.4 |

The examples were carried out using various suspensions prepared from these powders, in a manner similar to that from the example described in JP 2003-041240. The binder is polyethylene glycol, having a molecular weight of 200, supplied by VWR. Various amounts of powder were added to the binder. Table 6 provides the weight content of grains of the various suspensions thus obtained, as a percentage based on the weight of the suspension. The suspensions were then used to saw a silicon ingot, following the protocol described in the example from JP 2003-041240.

The speed of machining the silicon ingot with the abrasive wire (which rubs against the ingot in a plane perpendicular to the direction of travel of the silicon ingot), that is to say the number of ingots sawn per unit of time, was measured, each time under the same conditions.

The speeds obtained with the various suspensions were compared to the speed obtained with the suspension from example “Ref. 2′”. The ratio between the speed obtained with a suspension and the speed obtained with the suspension from the example of “Ref. 2′”, referred to as “gain G′”, makes it possible in particular to measure the impact of the powder of grains used (P1 or P2) and the weight content of grains.

Results

The results obtained are summarized in table 6 below:

TABLE 6

| | | Weight content of | |
|---|---|---|---|
| Powder | Example | grains | G′ (%) |
| P1 | Ref. 1 | 30 | 93 |
| | 1 | 37 | 112 |
| | 2 | 43 | 113 |
| | 3 | 45 | 105 |
| | Ref. 2 | 50 | 85 |
| P2 | Ref. 1′ | 30 | 99 |
| | 1′ | 37 | 103 |
| | 2′ | 43 | 104 |
| | 3′ | 45 | 103 |
| | Ref. 2′ | 50 | 100 |

The results obtained show that the performances of the suspensions according to the invention that were tested are superior to those obtained with reference suspensions at lower or higher weight contents of grains. A suspension according to the invention manufactured from a powder of elongated grains of type P1 has better performances than a suspension manufactured from a powder P2.

A suspension according to the invention thus permits a high sawing speed, that is to say a good productivity, but also the manufacture of wafers, especially silicon wafers, having a thickness that is very fine and especially less than 180 μm, or even less than 150 μm, or even of the order of 100 μm, with a low scrap rate.

The suspensions according to examples 1 and 2 are considered to be preferred out of all of them, the sawing speed being maximum for these examples.

As is now clearly apparent, the invention provides a particularly efficient suspension for cutting silicon wafers. With a suspension according to the invention, it is thus especially possible to manufacture photovoltaic cells having an efficiency between the amount of electrical energy generated and the amount of silicon used that is particularly advantageous.

Of course, the invention is not however limited to the embodiments described above, provided by way of illustrative examples.

In particular, a suspension according to the invention could be used in applications other than an abrasive wire. It could in particular be used for manufacturing other sawing tools or, more generally, other machining tools.

1. A suspension comprising an assembly of abrasive grains and a binder, said suspension being characterized such:
the D₄₀-D₆₀ particle size fraction of said assembly of abrasive grains comprises more than 15% and less than 80%, as volume percentages, of grains having a circularity of less than 0.85, the D₄₀ and D₆₀ percentiles being the percentiles of the cumulative particle size distribution curve of the grain sizes corresponding to the grain sizes that make it possible to separate the fractions constituted of 40% and 60%, as volume percentages, respectively, of the grains having the largest sizes; and
the abrasive grains represent more than 25% and less than 46% of the mass of said suspension.

2. The suspension as claimed in claim 1, wherein the D₄₀-D₆₀ particle size fraction of said assembly of abrasive grains comprises less than 40% of grains having a circularity of less than 0.85, as a volume percentage.

3. The suspension as claimed in claim 1, wherein the abrasive grains represent more than 37% and less than 43% of the mass of said suspension.

4. The suspension as claimed in claim 1, wherein the ratio R₄₀₋₆₀ of the volume percentage of grains having a circularity of less than 0.85 in the D₄₀-D₆₀ particle size fraction divided by the median size D₅₀ is greater than 1 and less than 5.

5. The suspension as claimed in claim 4, wherein the ratio R₄₀₋₆₀ of the volume percentage of grains having a circularity of less than 0.85 in the D₄₀-D₆₀ particle size fraction divided by the median size D₅₀ is greater than 1.5 and less than 3.

6. The suspension as claimed in claim 1, wherein:
25%<Δ₂₀₋₄₀₋₆₀<50% and/or
0%<Δ₄₀₋₆₀₋₈₀<20%,
“Δₙ₋ₘ₋ₚ” being the ratio (S(Dₙ-Dₘ)−S(Dₘ-Dₚ))/S(Dₘ-Dₚ) as a percentage, “S(Dᵢ-Dⱼ)” being the volume percentage of grains having a circularity of less than 0.85 in the Dᵢ-Dⱼ particle size fraction.

7. The suspension as claimed in claim 1, wherein the D₂₀-D₄₀ particle size fraction comprises more than 15%, as a volume percentage, of grains having a circularity of less than 0.85.

8. The suspension as claimed in claim 1, wherein the D₁₀-D₂₀ particle size fraction comprises more than 15%, as a volume percentage, of grains having a circularity of less than 0.85.

9. The suspension as claimed in claim 1, wherein the D₃-D₁₀ particle size fraction comprises more than 30% and/or the D₄₀-D₆₀ particle size fraction comprises less than 50%, as a volume percentage, of grains having a circularity of less than 0.85.

10. The suspension as claimed in claim 1, wherein the median size D₅₀ is greater than 3 μm and/or less than 30 μm.

11. The suspension as claimed in claim 1, in which the assembly of abrasive grains has a weight content of oxygen between 0.2% and 0.6%.

12. The suspension as claimed in claim 1, having a viscosity between 20 and 30 cPa·s, measured with a Brookfield DV-II+ Pro viscometer using spindle 63 and a rotational speed of 200 rpm.

13. An abrasive wire intended for sawing blocks, especially blocks of silicon, comprising abrasive grains fastened to a support or agglomerated with one another by means of a suspension as claimed in claim 1.

14. A process for sawing a block based on silicon using an abrasive wire as claimed in preceding claim 13, adapted so as to obtain, at the end of said sawing operation, a wafer having a thickness of less than 200 μm.

15. A process for machining an ingot, comprising the following operations:
a. preparation of a suspension by mixing a powder of abrasive grains and a binder;
b. machining of said ingot using an abrasive tool that is reloaded by passing through said suspension;
being such that, for the preparation of said suspension, the weight content of abrasive grains in said suspension is adjusted as a function of the specific surface area of said powder, the suspension being as claimed in claim 1.
